(19) United States
(12) Patent Application Publication
(10) Pub. No.: US 2009/0174696 A1
(43) Pub. Date: Jul. 9, 2009

(54) PLASMA DISPLAY DEVICE AND METHOD OF DRIVING THE SAME

(76) Inventor: Jae-Young Yeo, Suwon-si (KR)

Correspondence Address: CHRISTIE, PARKER & HALE, LLP, PO BOX 7068, PASADENA, CA, 91109-7068, US

(21) Appl. No.: 12/344,408

(22) Filed: Dec. 26, 2008

(30) Foreign Application Priority Data
Jan. 9, 2008 (KR) 10-2008-0002557

(51) Int. Cl. G09G 5/00; G09G 3/28

(52) U.S. Cl. 345/211; 345/60

(57) ABSTRACT

A plasma display device and a method of driving the same. The plasma display device includes a scan electrode driver for sequentially applying a scanning voltage to a plurality of scan electrodes in a first period of an address period, and an address electrode driver for applying an address voltage to an address electrode corresponding to light emitting discharge cells according to a plurality of subfield data corresponding to the first period. The address electrode driver is configured to apply a precharge voltage to the address electrode prior to the first period, and the address electrode driver is configured to commence the output of the precharge voltage at a point in time that does not overlap with a time period at which at least a part of the plurality of subfield data is input to the address electrode driver.

### CROSS-REFERENCE TO RELATED APPLICATION

This application claims priority to and the benefit of Korean Patent Application No. 10-2008-0002557 filed in the Korean Intellectual Property Office on Jan. 9, 2008, the entire content of which is incorporated herein by reference.

### BACKGROUND OF THE INVENTION

1. Field of the Invention

The present invention relates to a plasma display device and a method of driving the same.

2. Description of the Related Art

A plasma display device is a flat panel display that displays characters or images using plasma that is generated by a gas discharge. In a display panel of the plasma display device, a plurality of discharge cells (hereinafter referred to as “cells”) are arranged in a matrix form.

The plasma display device has a frame divided into a plurality of subfields each having a gray level weight value, and is driven in the plurality of subfields. Luminance of a cell is determined by the sum of weight values of the subfields in which a corresponding cell emits light among the plurality of subfields.

Further, each subfield includes a reset period, an address period, and a sustain period. The reset period is a period in which a wall charge state of a cell is initialized, and the address period is a period in which an address operation is performed in order to select a light emitting cell and a non-light emitting cell among the discharge cells. The sustain period is a period in which an image is displayed by sustain-discharging cells that are set as light emitting cells in the address period for a period corresponding to a weight value of the corresponding subfield.

In general, after applying a gradually rising voltage waveform (hereinafter referred to as a “reset rising waveform”) to a scan electrode in a reset period, by applying a gradually falling voltage waveform to the scan electrode, a weak discharge occurs between electrodes, whereby a wall charge state of a cell is initialized. Further, by applying a sustain discharge pulse to a scan electrode and a sustain discharge pulse with an opposite phase to a corresponding sustain electrode that extend in the same direction in a sustain period, a sustain discharge occurs in a cell that is set as a light emitting cell.

In the address period, a voltage (e.g., a predetermined voltage; hereinafter referred to as an “address voltage”) is applied to an address electrode corresponding to a cell selected to emit light, and by applying the address voltage, electromagnetic interference (EMI) occurs between a plurality of address electrode driving integrated circuits (IC) for driving the address electrode.

Typically, just before applying an address voltage, a voltage (hereinafter referred to as a “precharge voltage”) that is lower by a suitable level (e.g., a predetermined level) than an address voltage is applied to an address electrode driving integrated circuit, whereby occurrence of EMI due to application of an address voltage can be prevented or reduced.

However, at a point in time in which subfield data are input to the address electrode driving integrated circuit, if rising pulses of a precharge voltage are applied to the address electrode, the subfield data are distorted due to an effect of applying a precharge voltage, whereby dot noise is generated.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide to a plasma display device and a method of driving the same capable of preventing or reducing dot noise from being generated.

An exemplary embodiment of the present invention provides a plasma display device including: a plasma display panel including a plurality of first electrodes, a plurality of second electrodes, a plurality of third electrodes crossing the plurality of first electrodes and the plurality of second electrodes, and a plurality of discharge cells that are defined by the plurality of first electrodes, the plurality of second electrodes, and the plurality of third electrodes; a controller for dividing a frame into a plurality of subfields each having a weight value, and converting a plurality of image signals to a plurality of subfield data for representing light emitting states of the plurality of discharge cells in each subfield; a first electrode driver for sequentially applying a scanning voltage to the plurality of first electrodes in a first period of an address period; and a second electrode driver for applying an address voltage to a third electrode among the plurality of third electrodes corresponding to a light emitting one of the plurality of discharge cells that is defined by a corresponding one of the first electrodes to which the scanning voltage is applied according to the plurality of subfield data in the first period, and the second electrode driver configured to apply a precharge voltage to the plurality of third electrodes prior to the first period, wherein the second electrode driver includes a plurality of integrated circuits for receiving the plurality of subfield data and outputting the address voltage or the precharge voltage to the plurality of third electrodes. The plurality of integrated circuits are configured to commence outputting the precharge voltage at a point in time that does not overlap a second period in which at least a part of the plurality of subfield data is input to the integrated circuit.

Another exemplary embodiment of the present invention provides a method of driving a plasma display device that includes a plurality of integrated circuits that apply an address voltage corresponding to a plurality of subfield data to a plurality of address electrodes, the method including: inputting the plurality of subfield data corresponding to each of a plurality of scan electrodes to the plurality of integrated circuits; outputting a precharge voltage to the plurality of address electrodes; and applying the address voltage to one of the address electrodes corresponding to a light emitting discharge cell among a plurality of discharge cells that are defined by a scan electrode to which a scanning voltage is applied according to the subfield data. The outputting of a precharge voltage commences at a point in time different from another point in time at which at least a part of subfield data among the plurality of subfield data is input to the plurality of integrated circuits.

According to the embodiments of the present invention, upon applying a precharge voltage, because distortion of subfield data can be prevented or reduced, generation of dot noise may be suppressed.

### BRIEF DESCRIPTION OF THE DRAWINGS

FIG. 1 is a schematic block diagram illustrating a plasma display device according to an exemplary embodiment of the present invention.

FIG. 2 is a block diagram illustrating an address electrode driving integrated circuit according to an exemplary embodiment of the present invention.

FIG. 3 is a diagram illustrating driving waveforms of a plasma display device according to a first exemplary embodiment of the present invention.

FIG. 4 is a diagram illustrating driving waveforms of a plasma display device according to a second exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, unless explicitly described to the contrary, the word “comprise” and variations such as “comprises” or “comprising” will be understood to imply the inclusion of stated elements but not the exclusion of any other elements.

Further, “wall charges” that are described in this specification indicate charges that are formed adjacent to each electrode on a wall (e.g., a dielectric layer) of a cell. Wall charges may not actually contact with an electrode, however in this specification, it is described that wall charges are “formed,” “accumulated,” or “stacked” in the electrode, and a wall voltage indicates a potential difference that is formed in a wall of a cell by the wall charges.

A plasma display device and a method of driving the same according to an exemplary embodiment of the present invention are described hereinafter in detail with reference to the drawings.

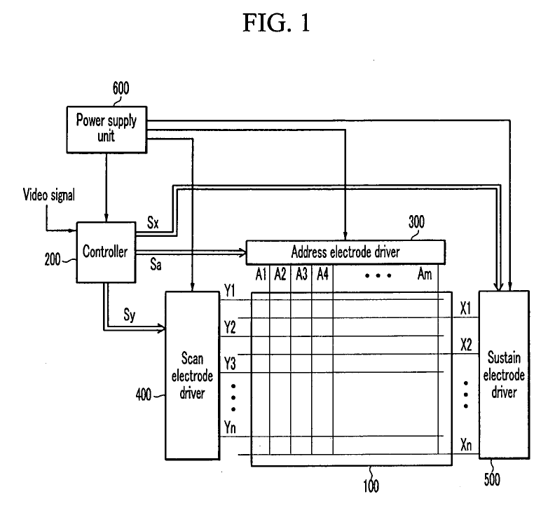

FIG. 1 is a block diagram illustrating a plasma display device according to an exemplary embodiment of the present invention.

As shown in FIG. 1, the plasma display device includes a plasma display panel (PDP) 100, a controller 200, an address electrode driver 300, a scan electrode driver 400, a sustain electrode driver 500, and a power supply unit 600.

The PDP 100 includes a plurality of address electrodes A1-Am that extend in a column direction, and a plurality of sustain electrodes X1-Xn and a plurality of scan electrodes Y1-Yn that are formed in pairs extend in a row direction.

The sustain electrodes X1-Xn are formed to correspond to the scan electrodes Y1-Yn, respectively, and the sustain electrodes X1-Xn are generally commonly connected to each other at one end. The PDP 100 includes a substrate (not shown) in which the sustain electrodes X1-Xn and the scan electrodes Y1-Yn are arranged, and another substrate (not shown) in which the address electrodes A1-Am are arranged. The two substrates are disposed to opposite each other with a discharge space therebetween. The scan electrodes Y1-Yn and the sustain electrodes X1-Xn may be orthogonal to the address electrodes A1-Am. Cells are formed in discharge spaces at crossings of the address electrodes A1-Am, the sustain electrodes X1-Xn and the scan electrodes Y1-Yn. The structure of the PDP 100 is an exemplary illustration, and the present invention can be applied to a panel of other structures to which driving waveforms to be described later may be applied.

The controller 200 receives a video signal from the outside and outputs an address electrode driving control signal Sa, a sustain electrode driving control signal Sx, and a scan electrode driving control signal Sy. The controller 200 divides a frame into a plurality of subfields each having a weight value and drives the plurality of subfields, and each subfield includes a reset period, an address period, and a sustain period with respect to time. The controller 200 converts an input video signal to subfield data that represent light emitting/non-light emitting in each subfield. For example, when a frame is divided into eight subfields each having a weight value of 1, 2, 4, 8, 16, 32, 64 and 128, subfield data corresponding to a gray level 115 may be represented as “11001110.”

Here, “0” represents non-light emitting and “1” represents light emitting in a corresponding subfield. In subfield data represented “11001110,” because light emits in first, second, fifth, sixth, and seventh subfields (SF1, SF2, SF5, SF6, and SF7), the gray level of 115 may be represented.

The address electrode driver 300 receives the address electrode driving control signal Sa and the subfield data from the controller 200, and applies an address voltage for selecting light emitting cells and non-light emitting cells among the cells to each of the address electrodes A1-Am. The address electrode driver 300 divides the address electrodes A1-Am into a plurality of groups to apply a precharge voltage to each group at different points in time in order to prevent or reduce occurrence of electromagnetic interference (EMI) that is caused by applying an address voltage.

The scan electrode driver 400 receives the scan electrode driving control signal Sy from the controller 200 and applies a driving voltage to the scan electrodes Y1-Yn.

The sustain electrode driver 500 receives the sustain electrode driving control signal Sx from the controller 200 and applies a driving voltage to the sustain electrodes X1-Xn.

The power supply unit 600 supplies power for driving a plasma display device to the controller 200 and each of the drivers 300, 400, and 500.

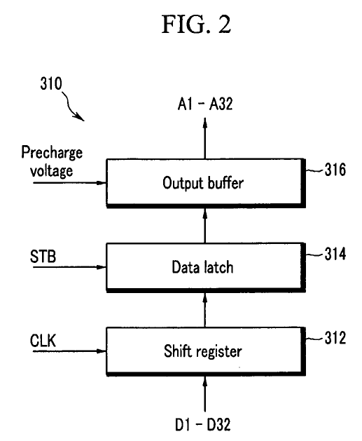

The address electrode driver 300 supplies a precharge voltage to the address electrodes A1-Am through an address electrode driving integrated circuit (not shown) at a point in time that is different from another point in time at which the subfield data is input to the address electrode driving integrated circuit, thereby preventing distortion of the subfield data, and this is described with reference to FIGS. 2 to 4.

First, an address electrode driving integrated circuit 310 that is included in the address electrode driver 300 is described with reference to FIG. 2.

FIG. 2 is a block diagram illustrating the address electrode driving integrated circuit 310 according to an exemplary embodiment of the present invention. The address electrode driver 300 includes a plurality of address electrode driving integrated circuits 310, and each of the address electrode driving integrated circuits 310 is formed to correspond to a group of address electrodes for applying a precharge voltage.

As shown in FIG. 2, the address electrode driving integrated circuit 310 includes a shift register 312, a data latch 314, and an output buffer 316. In FIG. 2, it is illustrated that the number of subfield data D1-D32 that are input to the address electrode driving integrated circuit 310 and the number of address voltages A1-A32 that are output from the address electrode driving integrated circuit 310 are both 32. The address electrode driving integrated circuit 310 may have input terminals and output terminals of a number that is different from the number that are shown in FIG. 2. Further, the number of output terminals of all address electrode driving integrated circuits 310 that are included in the address electrode driver 300 is identical to that of address electrodes A1-Am that are formed in the PDP 100.

The shift register 312 synchronizes subfield data D1-D32 that are input from the controller (200 in FIG. 1) with a clock signal CLK, sequentially shifts the subfield data D1-D32, and outputs the subfield data D1-D32 to the data latch 314.

The data latch 314 stores the subfield data D1-D32 that are input from the shift register 312 and outputs the subfield data D1-D32 to the output buffer 316 when a strobe (STB) signal is input.

The output buffer 316 converts (e.g., level shifts) subfield data (e.g., D1-D32) that are input from the data latch 314 to corresponding driving voltages and outputs generated address voltages (e.g., A1-A32) to corresponding address electrodes (e.g., A1-Am). Further, the output buffer 316 outputs a precharge voltage that is input from the power supply unit 600 to corresponding address electrodes (e.g., A1-Am).

All address electrode driving integrated circuits 310 that are included in the address electrode driver 300 transfer the subfield data (e.g., D1-D32) that are stored in the data latch 314 to the output buffer 316 when the strobe (STB) signal is applied after all the subfield data (e.g., D1-D32) that are input to each shift register 312 are stored in the data latch 314, thereby converting the subfield data (e.g., D1-D32) to address voltages (e.g., A1-A32) and concurrently outputting the address voltage to the address electrodes A1-Am.

The address electrode driver 300 repeatedly performs an operation of outputting an address voltage (e.g., A1-A32) corresponding to the subfield data (e.g., D1-D32) to the address electrodes A1-Am in each subfield, whereby light emitting of each cell is determined on a subfield basis.

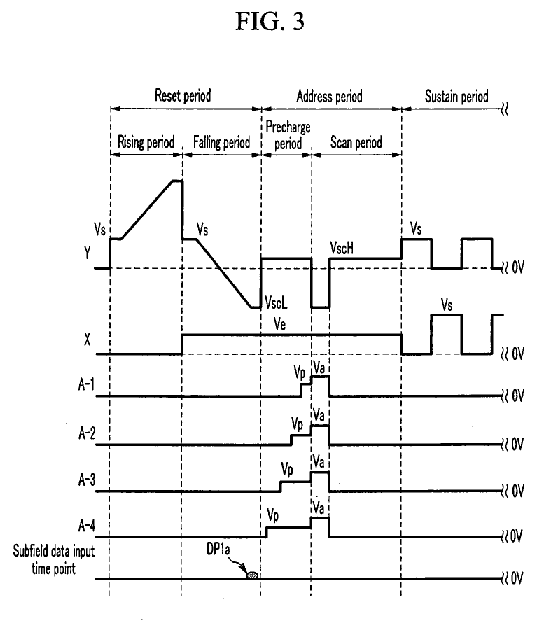

The address electrode driver 300 prevents or reduces distortion of the subfield data (e.g., D1-D32) by inputting the subfield data to the address electrode driving integrated circuits 310 earlier than a point in time at which a precharge voltage is output to the address electrodes (e.g., A1-Am), and this is described with reference to FIG. 3.

FIG. 3 is a diagram illustrating driving waveforms of a plasma display device according to a first exemplary embodiment of the present invention.

The driving waveforms of a plasma display device according to the first exemplary embodiment of the present invention that is shown in FIG. 3 show only driving waveforms within one subfield. One subfield of the PDP (100 in FIG. 1) includes a reset period, an address period, and a sustain period according to the different voltages applied to a sustain electrode X, a scan electrode Y, and an address electrode A under the control of the controller (200 in FIG. 1).

First, a reset period will be described. The reset period includes a rising period and a falling period. In the rising period, in a state where the address electrode A (e.g., A1-Am) and a sustain electrode X (e.g., X1-Xn) are sustained at a reference voltage (e.g., 0V in FIG. 3), a voltage of the scan electrode Y (e.g., Y1-Yn) gradually increases from a voltage Vs to a voltage Vset. The increase of the voltage of the scan electrode Y causes a feeble discharge (hereinafter referred to as a “weak discharge”) between the scan electrode Y and the sustain electrode X and between the scan electrode Y and the address electrode A, whereby negative (−) wall charges are formed on the scan electrode Y, and positive (+) wall charges are formed on the sustain electrode X and the address electrode A. The sum of a voltage that is applied from the outside and a wall voltage between electrodes due to wall charges that are formed when a voltage of the scan electrode Y reaches the voltage Vset, is identical to a discharge firing voltage Vf. A state of all cells should be initialized in the reset period, and thus the voltage Vset is set to a voltage suitably high to cause a discharge in a cell under all conditions. FIG. 3 shows an embodiment of the present invention where a voltage of the scan electrode Y increases or decreases in a ramp pattern. Alternatively, a different waveform that gradually increases or decreases may be applied.

In a falling period, in a state where the address electrode A and the sustain electrode X are sustained at a reference voltage (e.g., 0V in FIG. 3) and a voltage Ve, respectively, a voltage of the scan electrode Y is gradually decreased from a voltage Vs to a voltage VscL. The decrease of the voltage of the scan electrode Y causes a weak discharge between the scan electrode Y and the sustain electrode X and between the scan electrode Y and the address electrode A, whereby negative (−) wall charges that have been formed on the scan electrode Y during the rising period and positive (+) wall charges that have been formed on the sustain electrode X and the address electrode A are deleted or reduced. Therefore, negative (−) wall charges on the scan electrode Y, positive (+) wall charges on the sustain electrode X, and positive (+) wall charges on the address electrode A are decreased. For example, positive (+) wall charges on the address electrode A are decreased to an appropriate amount for an address operation. In general, a magnitude of a voltage VscL-Ve is set to about a discharge firing voltage Vf between the scan electrode Y and the sustain electrode X, and thus the difference of a wall voltage between the scan electrode Y and the sustain electrode X approaches almost 0V, and thereby a cell in which an address discharge does not occur in the address period is prevented from misfiring in the sustain period.

FIG. 3 shows that the reset period includes the rising period and the falling period, however a rising period of a reset period may selectively exist in each subfield. That is, a rising period of a reset period may or may not exist in each subfield.

The address period in FIG. 3 includes a precharge period and a scan period.

In the precharge period, in order to stably operate the address electrode driving integrated circuit 310 and to prevent or reduce the occurrence of EMI, a precharge voltage Vp is applied to the address electrodes A1-Am on a group basis at different points in time.

FIG. 3 illustrates that a precharge voltage Vp is applied to four groups (groups A-1, A-2, A-3, and A-4) among a plurality of groups that are generated by dividing the address electrodes A1-Am, and the precharge voltage Vp is lower than an address voltage Va, as shown in FIG. 3.

Prior to a precharge period, the address electrode driver 300 inputs subfield data to the address electrode driving integrated circuit 310, and the address electrode driving integrated circuit 310 waits with the subfield data stored in the data latch 314 at a point in time at which a precharge voltage is started to be applied to each of four groups (groups A-1, A-2, A-3, and A-4). Thereby, the subfield data are not distorted due to a precharge voltage. For example, subfield data that are shown in FIG. 3 are subfield data DP1 corresponding to scan pulses that are first applied to the scan electrode among scan pulses that are sequentially applied to a plurality of the scan electrodes Y in an address period, and subfield data corresponding to scan pulses after a second scan pulse is applied to the scan electrode Y are input to the address electrode A through the address electrode driving integrated circuit 310 just before a corresponding scan pulse is applied to the scan electrode Y.

FIG. 3 shows that the subfield data DP1 are input to the address electrode driving integrated circuit 310 before the start of the address period, but the subfield data DP1 may be input to the address electrode driving integrated circuit 310 in the address period. However, the subfield data DP1 should be input to the address electrode driving integrated circuit 310 earlier than a point in time at which a precharge voltage (e.g., Vp) is output to the address electrode (e.g., A1-AM). Further, unlike the embodiment of FIG. 3, the precharge period may be set to start from a point in time prior to an address period.

In the scan period, in order to select a cell to emit light, in a state where the voltage Ve is applied to the sustain electrode X, scan pulses having a voltage VscL (or scanning voltage) are sequentially applied to a plurality of scan electrodes Y. At the same time, an address voltage Va is applied to the address electrode A that passes through a cell selected to emit light among a plurality of cells that correspond to the scan electrode Y to which the voltage VscL is applied. Thereby, an address discharge occurs between the address electrode A to which the address voltage Va is applied and a scan electrode Y to which the voltage VscL is applied and between the scan electrode Y to which the voltage VscL is applied and a sustain electrode X corresponding to the scan electrode Y to which the voltage VscL is applied, whereby positive (+) wall charges are generated on the scan electrode Y and negative (−) wall charges are generated on each of the address electrode A and the sustain electrode X. A voltage VscH (e.g., a non-scan voltage) that is higher than the voltage VscL is applied to the scan electrode Y to which the voltage VscL is not applied, and a reference voltage (e.g., a 0V) is applied to an address electrode A of a discharge cell that is not selected.

In the sustain period, sustain discharge pulses alternately having a high level voltage (e.g., a voltage Vs in FIG. 3) and a low level voltage (e.g., a voltage 0V in FIG. 3) are applied to the scan electrode Y and the sustain electrode X. The sustain discharge pulses applied to the scan electrode Y are in opposite phase to those applied to the sustain electrode X. That is, when a voltage Vs is applied to the scan electrode Y, a voltage 0V is applied to the sustain electrode X, and when a voltage Vs is applied to the sustain electrode X, a voltage 0V is applied to the scan electrode Y. A discharge occurs between the scan electrode Y and the sustain electrode X by the voltage Vs and a wall voltage that is formed between the scan electrode Y and the sustain electrode X by an address discharge. Thereafter, a process of applying sustain discharge pulses to the scan electrode Y and the sustain electrode X is repeated a number of times corresponding to a weight value of a corresponding subfield.

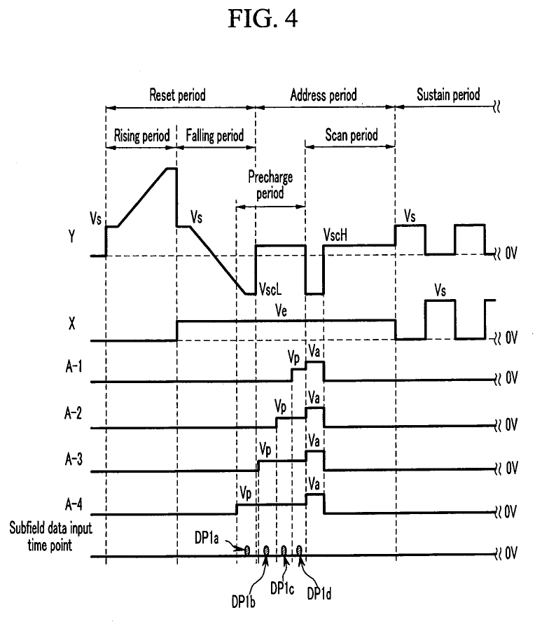

The address electrode driver 300 may prevent distortion of subfield data with a method different from the method that is shown in FIG. 3, and this is described with reference to FIG. 4.

FIG. 4 is a diagram illustrating driving waveforms of a plasma display device according to a second exemplary embodiment of the present invention. The driving waveforms of a plasma display device according to a second exemplary embodiment of the present invention that are shown in FIG. 4 is similar to the driving waveforms of a plasma display device according to a first exemplary embodiment of the present invention that are shown in FIG. 3, and therefore a detailed description thereof is omitted and only their differences are described.

The driving waveforms of a plasma display device according to the second exemplary embodiment of the present invention that are shown in FIG. 4 illustrate that the subfield data DP1 that is shown in FIG. 3 is divided into a plurality of subfield data (DP1a, DP1b, DP1c, and DP1d), and the plurality of subfield data (DP1a, DP1b, DP1c, and DP1d) are input to the address electrode driving integrated circuit 310 at different points in time. To prevent distortion of the subfield data, the subfield data (DP1a, DP1b, DP1c, and DP1d) are applied to the address electrode driving integrated circuit 310 in a precharge period so that a rising pulse applying time period of a precharge voltage (e.g., Vp) and an applying time period of any of the subfield data (DP1a, DP1b, DP1c, and DP1d) do not overlap. Thereafter, subfield data corresponding to a scan pulse after a second scan pulse is input to the address electrode A through the address electrode driving integrated circuit 310 just before a corresponding scan pulse is applied to the scan electrode Y, and this is identical to what was described with reference to FIG. 3.

The precharge period that is shown in FIG. 4 is longer than the precharge period that is shown in FIG. 3, and this is because the subfield data corresponding to FIG. 4 include an input time period.

A plasma display device according to an exemplary embodiment of the present invention sets a point in time at which the subfield data DP1 are input to the address electrode driving integrated circuit 310 to a time period before a precharge period or sets a point in time at which subfield data (e.g., DP1a, DP1b, DP1c, and DP1d) are input to the address electrode driving integrated circuit 310 at a time period not to overlap with a rising pulse of a precharge voltage (e.g., Vp). Thereby, in the plasma display device according to the exemplary embodiment of the present invention, subfield data are not distorted due to an effect of applying a precharge voltage, therefore dot noise can be prevented from being generated.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A plasma display device comprising:
a plasma display panel comprising a plurality of first electrodes, a plurality of second electrodes, a plurality of third electrodes crossing the plurality of first electrodes and the plurality of second electrodes, and a plurality of discharge cells defined by the plurality of first electrodes, the plurality of second electrodes, and the plurality of third electrodes;
a controller for dividing a frame into a plurality of subfields each having a weight value, and converting a plurality of image signals to a plurality of subfield data for representing light emitting states of the plurality of discharge cells in each subfield;
a first electrode driver for sequentially applying a scanning voltage to the plurality of first electrodes in a first period of an address period; and
a second electrode driver for applying an address voltage to a third electrode among the plurality of third electrodes corresponding to a light emitting one of the plurality of discharge cells that is defined by a corresponding one of the first electrodes to which the scanning voltage is applied according to the plurality of subfield data in the first period, and the second electrode driver configured to apply a precharge voltage to the plurality of third electrodes prior to the first period,
wherein the second electrode driver comprises a plurality of integrated circuits for receiving the plurality of subfield data and outputting the address voltage or the precharge voltage to the plurality of third electrodes, and
the plurality of integrated circuits are configured to commence outputting the precharge voltage at a point in time that does not overlap with a second period in which at least a part of the plurality of subfield data is input to the integrated circuits.

2. The plasma display device of claim 1, wherein the plurality of integrated circuits are divided into a plurality of groups, and
the plurality of groups are configured to start outputting the precharge voltage at different points in time.

3. The plasma display device of claim 2, wherein the second period precedes the different points in time.

4. The plasma display device of claim 2, wherein the second period is divided into a plurality of third periods, and
each of the third periods is between two adjacent points in time among the different points in time.

5. The plasma display device of claim 1, wherein each of the plurality of integrated circuits comprises:
a data latch;
a shift register for sequentially sampling the plurality of subfield data that are input from the controller and outputting the plurality of subfield data to the data latch; and
an output buffer for converting the plurality of subfield data from the data latch to the address voltage and outputting the address voltage.

6. The plasma display device of claim 5, wherein the data latch is configured to store at least a part of the plurality of subfield data that are input at the point in time in which the plurality of integrated circuits start outputting the precharge voltage.

7. The plasma display device of claim 1, wherein at least a part of the plurality of subfield data are subfield data corresponding to discharge cells among the plurality of discharge cells that are defined by the first electrode to which the scanning voltage is first applied among the plurality of first electrodes.

8. The plasma display device of claim 1, wherein the precharge voltage is lower than the address voltage.

9. A method of driving a plasma display device comprising a plurality of integrated circuits that apply an address voltage corresponding to a plurality of subfield data to a plurality of address electrodes, the method comprising:
inputting the plurality of subfield data corresponding to each of a plurality of scan electrodes to the plurality of integrated circuits;
outputting a precharge voltage to the plurality of address electrodes; and
applying an address voltage to one of the address electrodes corresponding to a light emitting discharge cell among a plurality of discharge cells that are defined by a scan electrode to which a scanning voltage is applied according to the subfield data,
wherein the outputting of a precharge voltage commences at a point in time different from another point in time at which at least a part subfield data among the plurality of subfield data are input to the plurality of integrated circuits.

10. The method of claim 9, further comprising dividing the plurality of address electrodes into two or more groups,
wherein the outputting of the precharge voltage comprises outputting to the two or more groups at different points in time on a group basis.

11. The method of claim 10, wherein the outputting of the precharge voltage is performed after the inputting of the plurality of subfield data.

12. The method of claim 10, wherein the inputting of the plurality of subfield data is alternately performed with the outputting of the precharge voltage at different time points on a group basis.

13. The method of claim 9, wherein the at least a part of subfield data corresponds to a plurality of discharge cells that are defined by a scan electrode to which the scanning voltage is first applied among the plurality of scan electrodes.

14. The method of claim 9, wherein the precharge voltage is lower than the address voltage.

15. A plasma display device comprising:
a plasma display panel comprising a plurality of scan electrodes, a plurality of sustain electrodes, a plurality of address electrodes crossing the plurality of scan electrodes and the plurality of sustain electrodes, and a plurality of discharge cells defined by the plurality of scan electrodes, the plurality of sustain electrodes, and the plurality of address electrodes;
a scan electrode driver for applying a scanning voltage to a scan electrode among the plurality of scan electrodes in a first period of an address period; and
an address electrode driver for applying a precharge voltage and an address voltage to an address electrode among the plurality of address electrodes corresponding to a light emitting one of the plurality of discharge cells,
wherein the address electrode driver is configured to commence outputting the precharge voltage at a point in time that does not overlap a time period in which at least a part of subfield data corresponding to the address voltage is input to the address electrode driver.

16. The plasma display device of claim 15, wherein the plurality of address electrodes are divided into a plurality of groups, and
the address electrode driver is configured to apply the precharge voltage to each of the plurality of groups at different points in time.

17. The plasma display device of claim 16, wherein the time period precedes said different points in time.

18. The plasma display device of claim 16, wherein the time period is divided into a plurality of time periods, and
each of the plurality of time periods is between two adjacent points in time among said different points in time.

19. The plasma display device of claim 1, wherein the precharge voltage is lower than the address voltage.
